(19) United States
(12) Patent Application Publication
(10) Pub. No.: US 2025/0384680 A1
(43) Pub. Date: Dec. 18, 2025

(54) VISUAL PROCESSING

(71) Applicant: Beijing Youzhuju Network Technology Co., Ltd., Beijing (CN)

(72) Inventors: Yi Jiang, Beijing (CN); Junke Wang, Beijing (CN); Zehuan Yuan, Beijing (CN)

(21) Appl. No.: 19/235,998

(22) Filed: Jun. 12, 2025

(30) Foreign Application Priority Data
Jun. 14, 2024 (CN) 202410773967.7

(51) Int. Cl. G06V 10/84

(52) U.S. Cl. CPC G06V 10/84

(57) ABSTRACT

According to embodiments of the disclosure, a method, an apparatus, a device, and a storage medium for visual processing are provided. A method includes: converting a plurality of image blocks divided from visual data into a plurality of embedding representations respectively, where the visual data includes an image or a video; extracting, by using a first processing block in a trained visual encoder, first feature information from the plurality of embedding representations according to a first attention mechanism; extracting, by using a second processing block in the visual encoder, second feature information from the first feature information according to a second attention mechanism; and generating, by using a tokenizer in the visual encoder, an encoding representation corresponding to the visual data based on the second feature information. In this manner, the encoding efficiency can be improved, and better universality and scalability can be achieved.

### CROSS-REFERENCE

The present application claims priority to Chinese Patent Application No. 202410773967.7, filed on Jun. 14, 2024, and entitled “VISUAL PROCESSING METHOD, APPARATUS, DEVICE, AND STORAGE MEDIUM”, the entirety of which is incorporated herein by reference.

### FIELD

Example embodiments of the present disclosure are generally related to the field of computer technologies, and in particular, to visual processing.

### BACKGROUND

In recent years, a generative model has developed rapidly in the field of artificial intelligence and has provided greater potential for generating visual content. At present, there are two mainstream visual generation methods, namely, a language model (abbreviated as LM) based method and a diffusion model based method. The LM-based method performs visual generation by using a sequence modeling capability of a language model to describe it as a prediction process of a next token, and each token may characterize a portion of visual data. The diffusion model gradually transforms noise into a coherent visual structure through reverse diffusion.

### SUMMARY

In a first aspect of the present disclosure, a method for visual processing is provided. The method includes: converting a plurality of image blocks divided from visual data into a plurality of embedding representations respectively, where the visual data includes an image or a video; extracting, by using a first processing block in a trained visual encoder, first feature information from the plurality of embedding representations according to a first attention mechanism; extracting, by using a second processing block in the visual encoder, second feature information from the first feature information according to a second attention mechanism, where the first attention mechanism includes one of the following, and the second attention mechanism includes the other of the following: a window attention mechanism in a spatial dimension, where the window attention mechanism is applied to respective video frames in the image or the video, and a causal attention mechanism in a temporal dimension, where the causal attention mechanism is applied between consecutive video frames in the video; and generating, by using a tokenizer in the visual encoder, an encoding representation corresponding to the visual data based on the second feature information.

In a second aspect of the present disclosure, an apparatus for visual processing is provided. The apparatus includes: an embedding representation conversion module configured to convert a plurality of image blocks divided from visual data into a plurality of embedding representations respectively, where the visual data includes an image or a video; a first feature information extraction module configured to extract, by using a first processing block in a trained visual encoder, first feature information from the plurality of embedding representations according to a first attention mechanism; a second feature information extraction module configured to extract, by using a second processing block in the visual encoder, second feature information from the first feature information according to a second attention mechanism, where the first attention mechanism includes one of the following, and the second attention mechanism includes the other of the following: a window attention mechanism in a spatial dimension, where the window attention mechanism is applied to respective video frames in the image or the video, and a causal attention mechanism in a temporal dimension, where the causal attention mechanism is applied between consecutive video frames in the video; and an encoding representation generation module configured to generate, by using a tokenizer in the visual encoder, an encoding representation corresponding to the visual data based on the second feature information.

In a third aspect of the present disclosure, an electronic device is provided. The device includes at least one processor and at least one memory. The at least one memory is coupled to the at least one processor and stores instructions for execution by the at least one processor. The instructions, when executed by the at least one processor, cause the device to perform the method according to the first aspect.

In a fourth aspect of the present disclosure, a computer-readable storage medium is provided. The medium stores a computer program that, when executed by a processor, causes the method according to the first aspect to be implemented.

In a fifth aspect of the present disclosure, a computer program product is provided. The computer program product includes a computer program, and the computer program, when executed by a processor, causes the method according to the first aspect to be implemented.

It should be understood that the content described in this part is not intended to limit key features or important features of the embodiments of the present disclosure, nor is it intended to limit the scope of the present disclosure. Other features of the present disclosure will become readily understandable from the following description.

### BRIEF DESCRIPTION OF THE DRAWINGS

The foregoing and other features, advantages, and aspects of embodiments of the present disclosure become more apparent with reference to the following description when taken in conjunction with the drawings. In the drawings, the same or similar reference numerals represent the same or similar elements, where:

FIG. 1 shows a schematic diagram of an example environment in which embodiments of the present disclosure can be implemented;

FIG. 2 shows a schematic diagram of an architecture of a visual encoder according to some embodiments of the present disclosure;

FIG. 3 shows a schematic diagram of an architecture of a visual encoder according to some embodiments of the present disclosure;

FIG. 4 shows a schematic diagram of a training process of a visual decoder according to some embodiments of the present disclosure;

FIG. 5 shows a schematic diagram of an environment in which embodiments of the present disclosure can be implemented;

FIG. 6 shows a schematic diagram of a process for visual processing according to some embodiments of the present disclosure;

FIG. 7 shows a block diagram of an apparatus for visual processing according to some embodiments of the present disclosure; and

FIG. 8 shows a block diagram of an electronic device in which one or more embodiments of the present disclosure can be implemented.

### DETAILED DESCRIPTION

Embodiments of the present disclosure are described in more detail below with reference to the drawings. Although some embodiments of the present disclosure are shown in the drawings, it should be understood that the present disclosure can be implemented in various forms and should not be construed as being limited to the embodiments set forth herein. Rather, these embodiments are provided for a thorough and complete understanding of the present disclosure. It should be understood that the drawings and the embodiments of the present disclosure are only for exemplary purposes, and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below.

It may be understood that data involved in the technical solutions (including but not limited to the data itself, and acquisition or use of the data) should comply with requirements of corresponding laws, regulations, and relevant provisions.

It may be understood that before using the technical solutions disclosed in the embodiments of the present disclosure, a user should be informed of a type, a usage scope, a usage scenario, and the like of personal information involved in the present disclosure in an appropriate manner according to relevant laws and regulations, and the user's authorization should be obtained.

For example, in response to receiving an active request from a user, prompt information is sent to the user to explicitly prompt the user that an operation requested by the user to be performed will require acquisition and use of the user's personal information, so that the user may independently select, based on the prompt information, whether to provide personal information to software or hardware such as an electronic device, an application, a server, or a storage medium that performs the operation of the technical solution of the present disclosure.

As an optional but non-restrictive implementation, in response to receiving the active request from the user, the prompt information is sent to the user in a manner such as a pop-up window, and the prompt information may be presented in the pop-up window in a text manner. Additionally, the pop-up window may carry a selection control for the user to select “agree” or “disagree” to provide the personal information to the electronic device.

It may be understood that the foregoing processes of notifying and obtaining the user's authorization are only schematic, and do not constitute a limitation on implementations of the present disclosure. Other manners that meet the requirements of the relevant laws and regulations may also be applied to the implementations of the present disclosure.

As used herein, the term “model” may learn an association between a corresponding input and output from training data, so that after the training is completed, a corresponding output may be generated for a given input. Generation of the model may be based on a machine learning technology. Deep learning is a machine learning algorithm that processes an input and provides a corresponding output by using a plurality of processing units. A neural network model is an example of a model based on deep learning. In the present disclosure, the “model” may also be referred to as a “machine learning model”, a “learning model”, a “machine learning network”, or a “learning network”, and these terms are used interchangeably herein.

A “neural network” is a machine learning network based on deep learning. The neural network can process an input and provide a corresponding output, and usually includes an input layer and an output layer and one or more hidden layers between the input layer and the output layer. A neural network used in a deep learning application usually includes many hidden layers, thereby increasing the depth of the network. The individual layers of the neural network are connected in sequence, so that an output of a former layer is provided as an input to a latter layer, where the input layer receives an input to the neural network, and an output of the output layer is used as a final output of the neural network. Each layer of the neural network includes one or more nodes (also referred to as processing nodes or neurons), and each node processes an input from a former layer.

Generally, machine learning may generally include three stages, namely, a training stage, a testing stage, and an application stage (also referred to as an inference stage). In the training stage, a given model may be trained by using a large amount of training data, and parameter values are continuously updated iteratively until the model can obtain consistent inference that meets an expected target from the training data. Through the training, the model may be considered to be capable of learning, from the training data, an association between an input and an output (also referred to as mapping from the input to the output). The parameter values of the trained model are determined. In the testing stage, a test input is applied to the trained model to test whether the model can provide a correct output, thereby determining the performance of the model. The testing stage may sometimes be incorporated in the training stage. In the application or inference stage, the trained model may be used to process an actual model input based on the parameter values obtained through the training, to determine a corresponding model output.

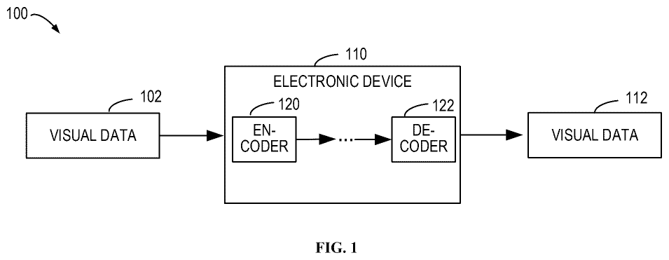

FIG. 1 shows a schematic diagram of an example environment 100 in which the embodiments of the present disclosure can be implemented. In the environment 100, an electronic device 110 may perform a visual processing task by using an encoder 120 and/or a decoder 122. In some implementations, the encoder 120 and the decoder 122 may be in the same electronic device 110 or in different electronic devices.

In some implementations, the electronic device 110 may generate visual data 112 by using the encoder 120 and the decoder 122 based on visual data 102, where the visual data 112 may be reconstruction data of the visual data 102.

In FIG. 1, the electronic device 110 may be any type of device with a computing capability, including a terminal device or a server-side device. The terminal device may be any type of mobile terminal, fixed terminal, or portable terminal, including a mobile phone, a desktop computer, a laptop, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination thereof, including accessories and peripherals of these devices or any combination thereof. The server-side device may include, for example, a computing system/server, such as a mainframe, an edge computing node, a computing device in a cloud environment, and the like.

It should be understood that the structure and function of the environment 100 are described for exemplary purposes only, without indicating any limitation on the scope of the present disclosure.

As briefly mentioned above, the LM-based method and the diffusion model are two mainstream methods for visual generation. The LM-based method redefines visual synthesis as a sequence prediction problem, similar to constructing a sentence in human language. The LM-based method may be further classified into an autoregressive model and a non-autoregressive model according to whether tokens are sequentially predicted or parallelly predicted. The autoregressive model utilizes an inherent sequential characteristic of the LM to generate an image and a video in a step-by-step manner. The non-autoregressive model achieves a faster generation process by independently and parallelly predicting a plurality of tokens.

Diffusion models represent another approach to visual generation, benefiting from their probabilistic nature of iteratively denoising a random signal into a structured image or video. Different from the LM that discretizes a visual input into latent encodings, the diffusion model directly generates a visual sample in a continuous pixel space. Although the diffusion model is effective, it requires a large amount of computing resources in view of the high dimensionality of visual data. Latent diffusion models (LDMs for short) attempt to alleviate these problems by using a pre-trained variational autoencoder (VAE) to compress high-dimensional visual data into a latent space.

The core of the above two methods is the tokenizer, which converts a visual signal into a latent representation. An LM tokenizer (for example, a vector quantization variational autoencoder (VQVAE)) may be used to discretize an input into a sequence of latent encodings, and a diffusion tokenizer (for example, a VAE) can be used to model a probability distribution of the latent representation in the latent space. The tokenizer used for visual synthesis determines the upper limit of the generative model, thereby attracting extensive attention.

Current tokenizers are specifically designed for image or video inputs, which results in limitations of the tokenizers in terms of application flexibility and data scalability of some generative models. For example, some generative models need to train separate tokenizers for image and video data, but cannot achieve cooperation between them.

To solve the above problem, in the embodiments of the present disclosure, a solution for visual processing is proposed. Specifically, a plurality of image blocks divided from visual data are respectively converted into a plurality of embedding representations, where the visual data includes an image or a video. First feature information is extracted from the plurality of embedding representations by using a first processing block in a trained visual encoder according to a first attention mechanism. Second feature information is extracted from the first feature information by using a second processing block in the visual encoder according to a second attention mechanism. The first attention mechanism includes one of the following, and the second attention mechanism includes the other of the following: a window attention mechanism in a spatial dimension, where the window attention mechanism is applied to respective video frames in the image or the video, and a causal attention mechanism in a temporal dimension, where the causal attention mechanism is applied between consecutive video frames in the video. An encoding representation corresponding to the visual data is generated by using a tokenizer in the visual encoder based on the second feature information.

According to the solution of the present disclosure, in the visual encoder, processing blocks in the spatial dimension and the temporal dimension are deployed in a decoupled manner, which can improve compatibility with static image data and dynamic video data. The window attention mechanism applied in the spatial dimension can better capture local features in the image or the video frame, and the causal attention mechanism applied in the temporal dimension can better capture the motion between consecutive video frames and ensure temporal coherence. Through joint encoding of the image and the video, the encoding efficiency can be improved, and better universality and scalability can be achieved.

Some example embodiments of the present disclosure are described below with reference to the drawings.

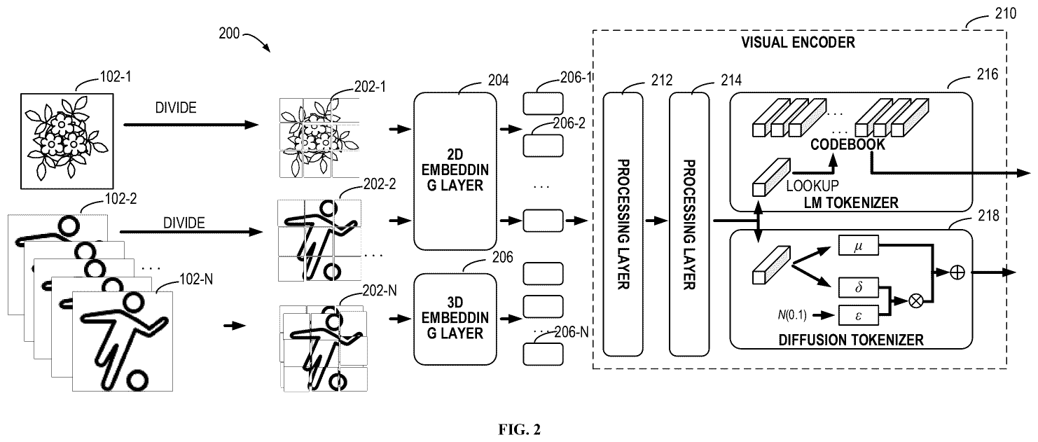

FIG. 2 shows a schematic diagram of an architecture 200 of a visual encoder according to some embodiments of the present disclosure.

As shown in FIG. 2, in a model inference stage of visual generation, a plurality of image blocks 202-1 to 202-N divided from visual data 102-1 to 102-N are respectively converted into a plurality of embedding representations 206-1 to 206-N (which may be collectively referred to as a plurality of embedding representations 206 for ease of description). The visual data may include an image 102-1 or a video including a plurality of video frames 102-2 to 102-N. That is, in the embodiments of the present disclosure, a unified visual encoder architecture may be designed to simultaneously support visual encoding of a static image and a video.

In some embodiments, the input image 102-1 may be divided into the plurality of image blocks 202-1, or respective video frames in the plurality of video frames 102-2 to 102-N of the input video may be divided into the plurality of image blocks. The plurality of image blocks 202-1 of the image 102-1 may be input into a two-dimensional (2D) embedding layer 204 to generate a part of the plurality of embedding representations 206. For the video data, the plurality of image blocks 202-2 corresponding to the first frame 102-2 of the video may also be input into the 2D embedding layer 204 to generate a part of the plurality of embedding representations 206 corresponding to the video. The consecutive frames 102-3 to 102-N after the first frame 102-2 in the video may be input into a three-dimensional (3D) embedding layer 206 to generate another part of the plurality of embedding representations 206 corresponding to the video.

In an example, given visual data x∈ [symbol] ^{(1+T)×H×W×3}, where (1+T) represents the number of frames (for an image, T=0) and H×W represents the spatial resolution. For joint encoding of a video and a static picture, the first frame x₀∈ [symbol] ^{1×H×W×3} and the subsequent frames x_{1:T}∈ [symbol] ^{T×H×W×3} may be processed separately. Specifically, x₀ and x_{1:T} are divided into non-overlapping data blocks, the size of the data block for the image is p×p, and the size of the data block for the video is t×p×p. Then, two linear layers (for example, the 2D embedding layer 204 and the 3D embedding layer 206) may be used to separately project the data block for the image and the data block for the video, to obtain embedding representations e₀∈ [symbol] ^{L}₁^{×c} and e_{1:T}∈ [symbol] ^{L}₂^{×c} where

$${L}_{1} = \frac{H}{p} \times \frac{W}{p} , {L}_{2} = \frac{T}{t} \times \frac{H}{p} \times \frac{W}{p} . {e}_{0} and {e}_{1 : T}$$

may be connected along the sequence dimension to obtain a spatial-temporal embedding representation e. In this manner, the resolution of the input visual data is compressed from

$$( 1 + T ) \times H \times W to ( 1 + \frac{T}{t} ) \times \frac{H}{p} \times \frac{W}{p} .$$

After the plurality of embedding representations 206 are obtained, first feature information may be extracted from the plurality of embedding representations by using a first processing block (for example, a processing layer 212) in a trained visual encoder 210 according to a first attention mechanism. Subsequently, second feature information may be extracted from the first feature information by using a second processing block (for example, a processing layer 214) in the visual encoder 210 according to a second attention mechanism. The first attention mechanism includes one of the following, and the second attention mechanism includes the other of the following: a window attention mechanism in a spatial dimension, where the window attention mechanism is applied to respective video frames in the image or the video, and a causal attention mechanism in a temporal dimension, where the causal attention mechanism is applied between consecutive video frames in the video. That is, for the input visual data, the window attention mechanism in the spatial dimension may be applied first and then the causal attention mechanism in the temporal dimension may be applied sequentially; or conversely, the causal attention mechanism in the temporal dimension may be applied first and then the window attention mechanism in the spatial dimension may be applied.

In some embodiments, the first processing block and the second processing block are based on a Transformer structure. The Transformer model can support a sequence of variable length, and therefore, the visual encoder 210 can process both a single-frame image and a multi-frame video, thereby improving the universality and scalability of the encoder 210.

In an example, the processing layer 212 may be one or more spatial transformer layers, the processing layer 214 may be one or more temporal transformer layers, or the processing layer 212 may be a temporal transformer layer(s), and the processing layer 214 may be a spatial transformer layer(s). The attention mechanism applied by the spatial transformer layer includes the window attention mechanism. The attention mechanism applied by the temporal transformer layer includes the causal attention mechanism.

For each spatial or temporal transformer layer, the input to the transformer layer is defined as a query feature, a key feature, and a value feature input to each transformer layer. The processing of the transformer layer may be expressed as follows:

$$Attention ( Q , K , V ) = softmax ( \frac{Q {K}^{T}}{\sqrt{{d}_{k}}} ) V \qquad ( 1 )$$

where Q represents the query feature, K represents the key feature, V represents the value feature, and dₖ represents the number of columns of Q and K, that is, the feature dimension. The above processing may be understood as calculating a self-attention weight matrix by using the query feature Q and the key feature K, and weighting and summing the value feature V with the self-attention weight matrix. In the processing of a general transformer layer, Q, K, and V are different projections of the same feature.

When the feature information is extracted according to the window attention mechanism, the image or each video frame may be first divided into a plurality of windows in the spatial dimension, and then the self-attention is calculated in each window according to the above formula (1). The window attention mechanism has higher computational efficiency and is easier to capture the local features of the image, and can accurately extract the feature information of the static image.

When the feature information is extracted according to the causal attention mechanism, the self-attention between consecutive video frames needs to be calculated according to the above formula (1). The causal attention mechanism can capture the motion between consecutive video frames and accurately obtain the feature information of the dynamic video.

After the second feature information is obtained, the encoding representation corresponding to the visual data may be generated by using the tokenizer in the visual encoder based on the second feature information. In some embodiments, the generated encoding representation may also be referred to as a token representation. The generated encoding representation may be understood as a compressed feature representation of the input visual input (image or video). The compressed feature representation may be stored or transmitted to other devices.

In some embodiments, the visual encoder 210 includes a first tokenizer (for example, an LM tokenizer 216) and a second tokenizer (for example, a diffusion tokenizer 218). The first tokenizer may be used to determine, from a codebook including visual encoding codewords, a plurality of visual encoding codewords that match the second feature information. In an example, given that the codebook Z includes a plurality of visual encoding codewords, determining the plurality of visual encoding codewords that match the second feature information from the codebook may be expressed as zₖ=lookup (Z, rₖ), where rₖ represents the second feature information, and zₖ represents the visual encoding codewords corresponding to the second feature information. The generated encoding representation may include a series of indexes of the visual encoding codewords in the codebook.

Alternatively or additionally, the second tokenizer may be used to determine the encoding representation corresponding to the visual data based on the second feature information and a predetermined distribution (for example, a Gaussian distribution). The second tokenizer is a tokenizer based on a diffusion model. The diffusion model, also referred to as a diffusion probability model, is a type of generative model. The data generation process of the diffusion model is based on a pair of Markov processes, namely, a forward diffusion process and a backward denoising process. The forward diffusion process (represented as

$$q ( {x}^{( 1 : T )} \vert {x}^{( 0 )} ) = {\prod }_{t = 1}^{T} q ( {x}^{( t )} \vert {x}^{( t - 1 )} ) )$$

gradually disturbs data x⁽⁰⁾˜q(x⁽⁰⁾), and obtains a static noise distribution x^{(T)}˜qₙₒᵢₛₑ through T gradual noise adding steps x^{(1:T)}=x₁, . . . , x^{(t-1)}, x^{(t)}, . . . , x^{(T)}. Through model training, the learned backward denoising process (represented as

$${p}_{θ} ( {x}^{( 0 : T )} ) = p ( {x}^{( t )} ) {\prod }_{t = 1}^{T} {p}_{θ} ( {x}^{( t - 1 )} \vert {x}^{( t )} ) )$$

performs an opposite process, and gradually denoises the sample toward the data distribution to obtain the data x⁽⁰⁾˜q(x⁽⁰⁾) It can be seen that the backward denoising process may correspond to a desired data modeling process, and the desired data is finally obtained.

According to the above description, the encoding representation of the input visual data may be generated by using the visual encoder. In some embodiments, the generated encoding representation may be used to reconstruct the visual data. In some embodiments, the encoding representation may be modified based on conditional information, so as to obtain a new encoding representation. Then, new visual data may be decoded based on the new encoding representation, thereby implementing conditional visual generation. In the visual data reconstruction and the conditional visual generation, the visual decoder may be used to decode the visual encoding representation.

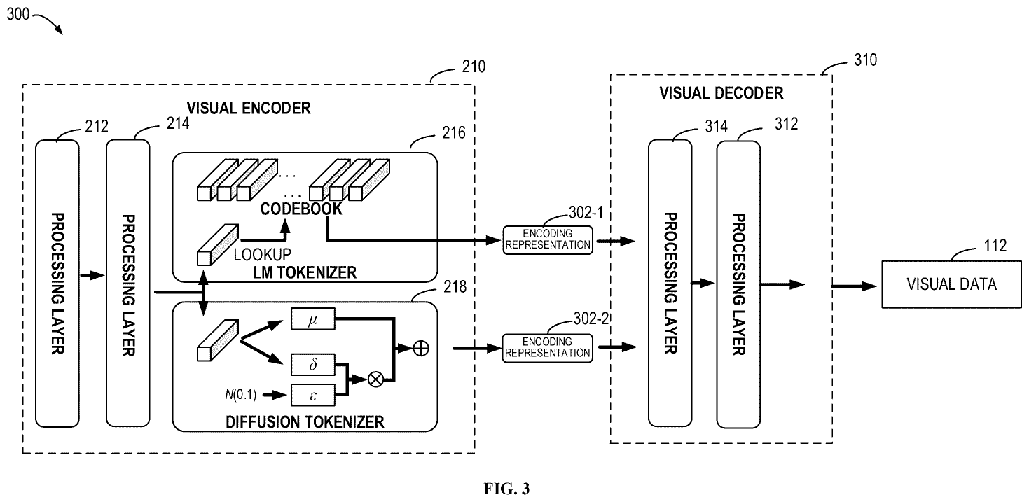

The visual decoder is described below with reference to FIG. 3, which shows a schematic diagram of an architecture 300 of a visual encoder according to some embodiments of the present disclosure.

As shown in FIG. 3, in some implementations, after encoding representations 302-1 and 302-2 (which may be collectively referred to as the encoding representation 302 for ease of description) corresponding to the visual data are generated, the visual data 112 may be decoded from the encoding representations 302 by using the trained visual decoder 310. In the process of image reconstruction, the visual decoder 310 decodes the encoding representations 302 to obtain the visual data 112 (that is, the reconstruction data of the visual data 102) through operations such as dequantization and inverse transformation.

Alternatively or additionally, additional visual data 112 is generated based on the encoding representation 302 and the conditional information. In some embodiments, the encoding representation 302 may be modified based on the conditional information in the visual encoder 210, specifically in the tokenizer of the visual encoder 210, to obtain a modified encoding representation. Then, the visual decoder 310 may generate additional visual data 112 according to the modified encoding representation. Since the modified encoding representation 302 is matched to the conditional information, the generated visual data 112 will meet a condition desired by the user.

In an example, additional visual data 112 may be generated based on the LM tokenizer. After the visual encoder 210 encodes the image or video input into the encoding representation 302, the encoding representation 302 may be flattened in sequence (for example, in a raster order) to obtain an encoding representation y. Then, the LM tokenizer 216 may be trained by using a cross-entropy loss function to maximize the log-likelihood between a predicted encoding representation ŷ and a target encoding representation y, which is expressed as follows:

$$maximize {\sum }_{i = 1}^{L} log P ( \vert c , {y}_{1 : i - 1} ; θ ) . \qquad ( 2 )$$

where c represents the conditional information (for example, a category label for conditional image and video generation), θ represents a learnable parameter in the LM used by the LM tokenizer 216, P represents a probability of a normalized exponential function (softmax), and L represents the length of y. In the inference stage, the predicted encoding representation ŷ is output according to the likelihood of the model. The encoding representation ŷ meets the conditional information, and the corresponding new visual data may be decoded by the visual decoder 310.

In an example, additional visual data 112 may be generated based on the LDM. The LDM may perform diffusion processing in the latent space to achieve high-quality image synthesis with improved computational efficiency. Specifically, the diffusion process may gradually apply Gaussian noise to the encoding representation 302 to generate a perturbed sample, while the denoising process trains the diffusion model to predict the added noise. In the inference process of the visual decoder 310, the trained diffusion model may generate a coherent visual sample from the noise by iteratively reversing the noise process.

In some embodiments, the structure of the visual decoder 310 is symmetric to the structure of the visual encoder 210. The visual decoder 310 includes at least a third processing block (for example, a processing layer 314) and a fourth processing block (for example, a processing layer 312) that are connected. An input to the third processing block is processed in the third processing block according to the second attention mechanism, and an input to the fourth processing block is processed in the fourth processing block according to the first attention mechanism. Considering the symmetry with the visual encoder 210, that is, the third processing block corresponds to the second processing block, and the fourth processing block corresponds to the first processing block. The third processing block may receive and process the encoding representation 302, and provide the processed output to the fourth processing block. After processing the input, the fourth processing block may output a plurality of image blocks, and these image blocks may be combined into a final image or video. The processing of the visual decoder 310 may be understood as an inverse process of the processing of the visual encoder 210, and will not be described in detail here.

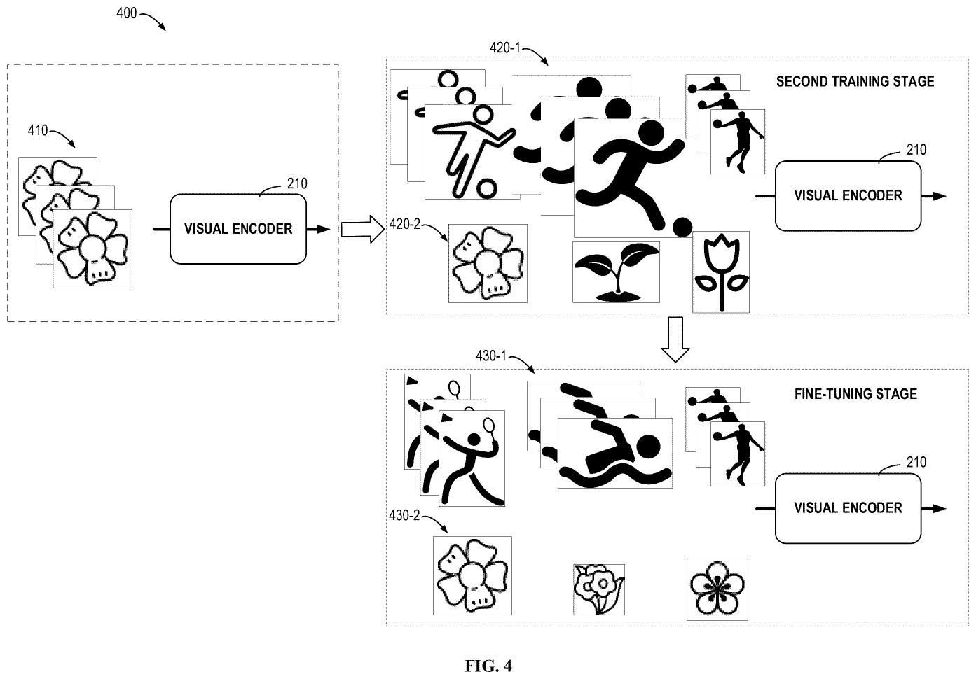

The training process of the visual decoder 210 is described below with reference to FIG. 4, which shows a schematic diagram of a training process 400 of the visual decoder 210 according to some embodiments of the present disclosure.

As shown in FIG. 4, in the first training stage, the visual encoder 210 may be trained by using a sample image set 410 with a fixed resolution. In the second training stage, the visual encoder 210 may be trained by using a sample image set 420-1 with different resolutions and a sample video set 420-2 with different resolutions. The training image sets in the first training stage and the second training stage may be the same, different, or partially overlapped. Training with the image with the fixed resolution in the first training stage can establish a basic understanding of the visual encoder 210 on the static visual information. Training with the sample image set and the sample video set with different resolutions in the second training stage can enable the visual encoder 210 to capture the dynamic visual information in a complex scene. In this manner, the visual encoder 210 can learn a universal embedding representation, and the embedding representation can accurately capture the spatial characteristics in a single frame and the temporal relationship in the continuous video data.

In some embodiments, the visual encoder 210 includes a first tokenizer and a second tokenizer. In the first training stage and the second training stage, a parameter of the first processing block, a parameter of the second processing block, and a parameter of the first tokenizer in the visual encoder are updated, while a parameter of the second tokenizer remains unchanged. In an example, the first tokenizer is the LM tokenizer 216, and the second tokenizer is the diffusion tokenizer 218. In the first and second training stages, the visual encoder 210 is trained with a target of vector quantization, which is expressed as follows:

$${ℒ}_{VQ} = {λ}_{1} {‖ sg [ E ( e ) ] - {z}_{q} ‖}_{2}^{2} + {λ}_{2} {‖ E ( e ) - sg [ {z}_{q} ] ‖}_{2}^{2} \qquad ( 3 )$$

where sg represents a stop gradient operation, λ₁ and λ₂ represent balance hyperparameters, and E and z_{q} represent the visual encoder 210 and a codebook vector, respectively. The parameters of the first processing block, the second processing block, and the first tokenizer are updated by reducing or minimizing the value of the loss function calculated by formula (3). It should be understood that in the first and second training stages, in addition to using the function in the above formula (3), other different or more loss functions may also be considered to optimize the LM tokenizer 216 and the processing layer in the video encoder 210.

In some embodiments, in a fine-tuning stage after the second training stage, a parameter of the first processing block, a parameter of the second processing block, and a parameter of the second tokenizer in the visual encoder may be updated by using a further sample image set 430-1 with different resolutions and a further sample video set 430-2 with different resolutions, while a parameter of the first tokenizer remains unchanged. The training image set or the training video set in the fine-tuning stage may be the same as, different from, or partially overlapped with the training image set or the training video set in the first training stage and the second training stage.

After the two stages of training described above, the visual encoder 210 and the diffusion tokenizer 218 may be fine-tuned by replacing the vector quantization loss with a KL divergence loss, and the KL divergence loss is expressed as follows:

$${ℒ}_{KL} = {λ}_{3} {D}_{KL} ( Q ( z \vert x ) ‖ P ( z ) ) \qquad ( 4 )$$

where P(z) represents a Gaussian distribution, and Q(z|x) represents an inferred posterior configuration of the encoding representation given the observed input. It should be understood that in the fine-tuning stage, in addition to using the function in the above formula (4), other different or more loss functions may also be considered to optimize the diffusion tokenizer 218 and the processing layer in the video encoder 210.

In some embodiments, the first tokenizer is the diffusion tokenizer 218, and the second tokenizer is the LM tokenizer 216. In this case, the diffusion tokenizer 218 is trained based on the KL divergence loss [symbol] _{KL} in the first training stage and the second training stage, and the LM tokenizer 216 is trained based on the vector quantization loss [symbol] _{VQ} in the fine-tuning stage.

In addition to the above [symbol] _{VQ} and [symbol] _{KL}, the first training stage, the second training stage, and the fine-tuning stage may also use L₂ reconstruction loss [symbol] _{recon} and generative adversarial network (GAN) loss [symbol] _{GAN}.

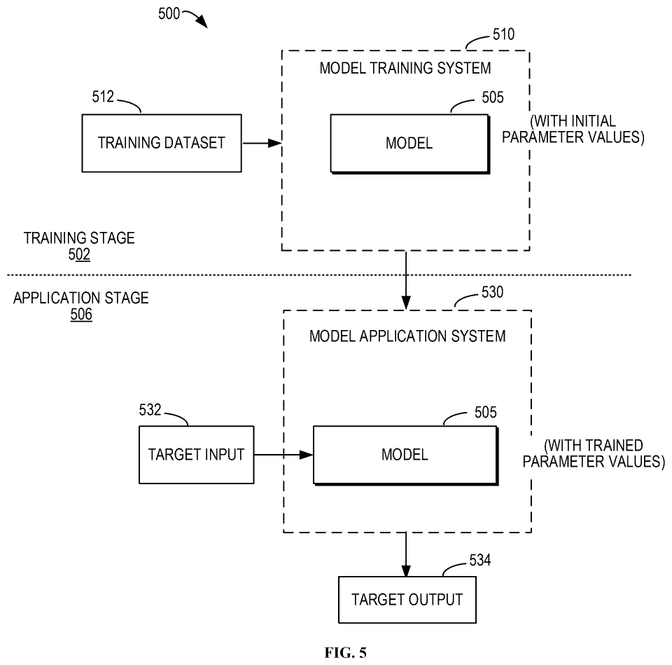

FIG. 5 shows a schematic diagram of an environment 500 in which the embodiments of the present disclosure can be implemented. In the environment 500 in FIG. 5, it is generally shown that the model involves different stages, including a training stage 502 and an application stage 506. After the training stage is completed, there may also be a testing stage, which is not shown in the figure.

In the training stage 502, a model training system 510 is configured to perform training of a model 505 by using a training dataset 512. The model 505 may be, for example, the visual encoder 210 in FIG. 2 or the visual decoder 310 in FIG. 3. At the beginning of the training, the model may have initial parameter values. The training process is to update the parameter values of the model 505 to desired values based on the training data.

In the application stage 506, the obtained model 505 that has the trained parameter values may be provided to a model application system 530 for use. In the application stage 506, the model 505 may be used to process a corresponding target input 532 in an actual scenario, and provide a corresponding target output 534. The model application system 530 may be configured to implement the electronic device 110 in FIG. 1.

In FIG. 5, the model training system 510 and the model application system 530 may include any computing system with a computing capability, such as various computing devices/systems, terminal devices, servers, and the like. The terminal device may involve any type of mobile terminal, fixed terminal, or portable terminal, including a mobile phone, a desktop computer, a laptop, a notebook computer, a netbook computer, a tablet computer, a media computer, a multimedia tablet, or any combination thereof, including accessories and peripherals of these devices or any combination thereof. The server includes but is not limited to a mainframe, an edge computing node, a computing device in a cloud environment, and the like.

It should be understood that the components and arrangements in the environment 500 shown in FIG. 5 are only examples, and a computing system suitable for implementing the exemplary implementations described in the present disclosure may include one or more different components, other components, and/or different arrangements. For example, although shown as being separate, the model training system 510 and the model application system 530 may be integrated in the same system or device. The implementations of the present disclosure are not limited in this aspect.

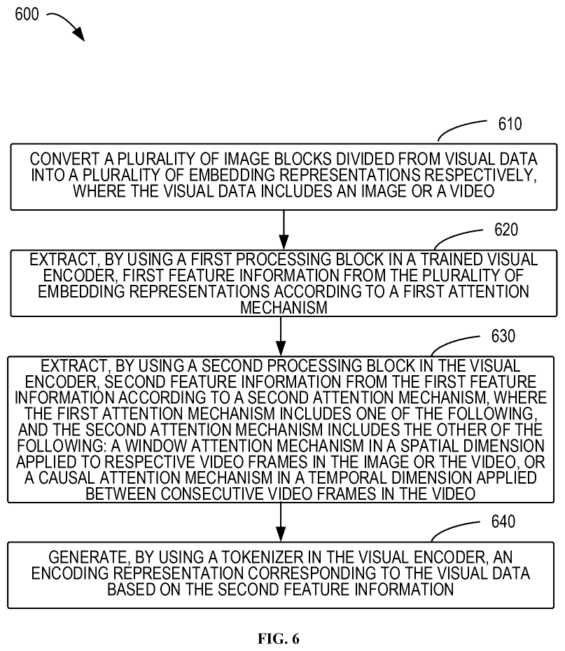

FIG. 6 shows a schematic diagram of a process 600 for visual processing according to some embodiments of the present disclosure. The process 600 may be implemented at the electronic device 110 in FIG. 1.

At block 610, the electronic device 110 converts a plurality of image blocks divided from visual data into a plurality of embedding representations respectively, where the visual data includes an image or a video.

At block 620, the electronic device 110 extracts, by using a first processing block in a trained visual encoder, first feature information from the plurality of embedding representations according to a first attention mechanism.

At block 630, the electronic device 110 extracts, by using a second processing block in the visual encoder, second feature information from the first feature information according to a second attention mechanism, where the first attention mechanism includes one of the following, and the second attention mechanism includes the other of the following: a window attention mechanism in a spatial dimension, where the window attention mechanism is applied to respective video frames in the image or the video, and a causal attention mechanism in a temporal dimension, where the causal attention mechanism is applied between consecutive video frames in the video.

At block 640, the electronic device 110 generates, by using a tokenizer in the visual encoder, an encoding representation corresponding to the visual data based on the second feature information.

In some embodiments, the visual encoder includes a first tokenizer and a second tokenizer, and the generating the encoding representation corresponding to the visual data includes: determining, by using the first tokenizer, a plurality of visual encoding codewords that match the second feature information from a codebook including visual encoding codewords; and/or determining, by using the second tokenizer, the encoding representation corresponding to the visual data based on the second feature information and a predetermined distribution.

In some embodiments, the first processing block and the second processing block are based on a Transformer model structure.

In some embodiments, the process 600 further includes decoding, by using a trained visual decoder, the visual data from the encoding representation; or generating, by using the visual decoder, additional visual data based on the encoding representation and conditional information.

In some embodiments, the visual decoder includes at least a third processing block and a fourth processing block that are connected, where an input to the third processing block is processed in the third processing block according to the second attention mechanism, and an input to the fourth processing block is processed in the fourth processing block according to the first attention mechanism.

In some embodiments, the training process of the visual encoder includes at least: training the visual encoder by using a sample image set with a fixed resolution in a first training stage; and training the visual encoder by using a sample image set with different resolutions and a sample video set with different resolutions in a second training stage.

In some embodiments, the visual encoder includes a first tokenizer and a second tokenizer, and in the first training stage and the second training stage, a parameter of the first processing block, a parameter of the second processing block, and a parameter of the first tokenizer in the visual encoder are updated, while a parameter of the second tokenizer remains unchanged.

In some embodiments, the training process of the visual encoder further includes: in a fine-tuning stage after the second training stage, updating a parameter of the first processing block, a parameter of the second processing block, and a parameter of the second tokenizer in the visual encoder by using a further sample image set with different resolutions and a further sample video set with different resolutions, while keeping a parameter of the first tokenizer unchanged.

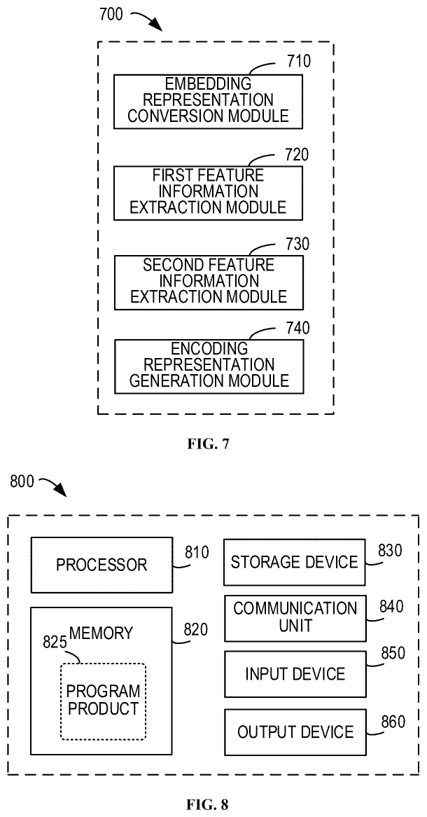

FIG. 7 shows a block diagram of an apparatus 700 for visual processing according to some embodiments of the subject matter described herein. The apparatus 700 may be implemented or included at the electronic device 110 in FIG. 1. The individual modules/components in the apparatus 700 may be implemented by hardware, software, firmware, or any combination thereof.

As shown in FIG. 7, the apparatus 700 includes an embedding representation conversion module 710 configured to convert a plurality of image blocks divided from visual data into a plurality of embedding representations respectively, where the visual data includes an image or a video. The apparatus 700 includes a first feature information extraction module 720 configured to extract, by using a first processing block in a trained visual encoder, first feature information from the plurality of embedding representations according to a first attention mechanism. The apparatus 700 includes a second feature information extraction module 730 configured to extract, by using a second processing block in the visual encoder, second feature information from the first feature information according to a second attention mechanism, where the first attention mechanism includes one of the following, and the second attention mechanism includes the other of the following: a window attention mechanism in a spatial dimension, where the window attention mechanism is applied to respective video frames in the image or the video, and a causal attention mechanism in a temporal dimension, where the causal attention mechanism is applied between consecutive video frames in the video. The apparatus 700 includes an encoding representation generation module 740 configured to generate, by using a tokenizer in the visual encoder, an encoding representation corresponding to the visual data based on the second feature information.

In some embodiments, the visual encoder includes a first tokenizer and a second tokenizer, and the encoding representation generation module 740 is further configured to determine, by using the first tokenizer, a plurality of visual encoding codewords that match the second feature information from a codebook including visual encoding codewords; and/or determine, by using the second tokenizer, the encoding representation corresponding to the visual data based on the second feature information and a predetermined distribution.

In some embodiments, the first processing block and the second processing block are based on a Transformer model structure.

In some embodiments, the apparatus 700 further includes a decoding module configured to decode the visual data from the encoding representation by using a trained visual decoder; or generate additional visual data by using the visual decoder based on the encoding representation and the conditional information.

In some embodiments, the visual decoder includes at least a third processing block and a fourth processing block that are connected, where an input to the third processing block is processed in the third processing block according to the second attention mechanism, and an input to the fourth processing block is processed in the fourth processing block according to the first attention mechanism.

In some embodiments, the training process of the visual encoder includes at least: training the visual encoder by using a sample image set with a fixed resolution in a first training stage; and training the visual encoder by using a sample image set with different resolutions and a sample video set with different resolutions in a second training stage.

In some embodiments, the visual encoder includes a first tokenizer and a second tokenizer, and in the first training stage and the second training stage, a parameter of the first processing block, a parameter of the second processing block, and a parameter of the first tokenizer in the visual encoder are updated, but a parameter of the second tokenizer remains unchanged.

In some embodiments, the training process of the visual encoder further includes: in a fine-tuning stage after the second training stage, updating a parameter of the first processing block, a parameter of the second processing block, and a parameter of the second tokenizer in the visual encoder by using a further sample image set with different resolutions and a further sample video set with different resolutions, but keeping a parameter of the first tokenizer unchanged.

FIG. 8 shows a block diagram of an electronic device 800 in which one or more embodiments of the present disclosure can be implemented. It should be understood that the electronic device 800 shown in FIG. 8 is only exemplary, and should not constitute any limitation on the function and scope of the embodiments described herein. The electronic device 800 shown in FIG. 8 may be used to implement the electronic device 110 in FIG. 1 or the apparatus 700 in FIG. 7.

As shown in FIG. 8, the electronic device 800 is in the form of a general-purpose computing device. The components of the electronic device 800 may include but not be limited to one or more processors or processing units 810, a memory 820, a storage device 830, one or more communication units 840, one or more input devices 850, and one or more output devices 860. The processor 810 may be a physical or virtual processor and can perform various processing according to a program stored in the memory 820. In a multi-processor system, a plurality of processing units execute computer-executable instructions in parallel to improve the parallel processing capability of the electronic device 800.

The electronic device 800 generally includes a plurality of computer storage media. Such a medium may be any available medium accessible by the electronic device 800, including but not limited to, a volatile and non-volatile medium, and a detachable and non-detachable medium. The memory 820 may be a volatile memory (for example, a register, a cache, a random access memory (RAM)), a non-volatile memory (for example, a read-only memory (ROM), an electrically erasable programmable read-only memory (EEPROM), a flash memory), or a combination thereof. The storage device 830 may be a detachable or non-detachable medium, and may include a machine-readable medium, such as a flash drive, a magnetic disk, or any other medium, which may be used to store information and/or data and may be accessed within the electronic device 800.

The electronic device 800 may further include another detachable/non-detachable, volatile/non-volatile storage medium. Although not shown in FIG. 8, a disk drive may be provided for reading from or writing to a detachable, non-volatile magnetic disk (for example, a “floppy disk”), and an optical disk drive may be provided for reading from or writing to a detachable, non-volatile optical disk. In these cases, each drive may be connected to a bus (not shown) by one or more data medium interfaces. The memory 820 may include a computer program product 825 having one or more program modules configured to perform various methods or actions of various embodiments of the present disclosure.

The communication unit 840 enables communication with other electronic devices through a communication medium. Additionally, the functions of the components of the electronic device 800 may be implemented with a single computing cluster or a plurality of computing machines that can communicate through a communication connection. Therefore, the electronic device 800 may operate in a networked environment using a logical connection to one or more other servers, network personal computers (PCs), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) through the communication unit 840 as required, the external devices such as a storage device, a display device, etc., communicate with one or more devices that enable the user to interact with the electronic device 800, or communicate with any device (for example, a network card, a modem, etc.) that enables the electronic device 800 to communicate with one or more other electronic devices. Such communication may be performed via an input/output (I/O) interface (not shown).

According to an exemplary implementation of the present disclosure, a computer-readable storage medium is provided, which stores computer-executable instructions, where the computer-executable instructions are executed by a processor to implement the method described above. According to an exemplary implementation of the present disclosure, a computer program product is further provided, which is tangibly stored on a non-transitory computer-readable medium and includes computer-executable instructions, where the computer-executable instructions are executed by a processor to implement the method described above.

Various aspects of the present disclosure are described herein with reference to flowcharts and/or block diagrams of the method, apparatus, device, and computer program product implemented according to the present disclosure. It should be understood that each block of the flowcharts and/or block diagrams and a combination of blocks in the flowcharts and/or block diagrams may be implemented by computer-readable program instructions.

These computer-readable program instructions may be provided to a processing unit of a general-purpose computer, a special-purpose computer, or other programmable data processing apparatuses, to produce a machine, so that the instructions, when executed by the processing unit of the computer or the other programmable data processing apparatuses, produce an apparatus for implementing functions/actions specified in one or more blocks in the flowcharts and/or block diagrams. These computer-readable program instructions may also be stored in a computer-readable storage medium, and these instructions cause the computer, the programmable data processing apparatus, and/or other devices to work in a specific manner, so that the computer-readable medium storing the instructions includes an article of manufacture, which includes instructions for implementing various aspects of the functions/actions specified in one or more blocks in the flowcharts and/or block diagrams.

The computer-readable program instructions may be loaded onto the computer, other programmable data processing apparatus, or other device, such that a series of operational steps are performed on the computer, other programmable data processing apparatus, or other device to produce a computer-implemented process, such that the instructions executed on the computer, other programmable data processing apparatus, or other device implement the functions/actions specified in one or more blocks in the flowcharts and/or block diagrams.

The flowcharts and block diagrams in the drawings show possible architectures, functions, and operations of the system, method, and computer program product implemented according to multiple implementations of the present disclosure. In this regard, each block in the flowcharts or block diagrams may represent a module, a program segment, or a portion of instructions, and the module, the program segment, or the portion of instructions contains one or more executable instructions for implementing specified logical functions. In some alternative implementations, the functions noted in the blocks may also occur out of the order noted in the drawings. For example, two consecutive blocks may, in fact, be performed substantially concurrently, or the blocks may sometimes be performed in a reverse order, depending upon the functionality involved. It is also noted that each block of the block diagrams and/or flowcharts and a combination of blocks in the block diagrams and/or flowcharts may be implemented by a special-purpose hardware-based system that performs the specified functions or actions or a combination of special-purpose hardware and computer instructions.

The implementations of the present disclosure have been described above, and the foregoing description is exemplary, not exhaustive, and is not limited to the disclosed implementations. Many modifications and variations will be apparent to those of ordinary skill in the art without departing from the scope and spirit of the described implementations. The terminology used herein is chosen to best explain the principles of the implementations, the practical application, or the improvement of the technology in the marketplace, or to enable other ordinary skilled in the art to understand the implementations disclosed herein.

1. A method for visual processing, comprising:
converting a plurality of image blocks divided from visual data into a plurality of embedding representations respectively, wherein the visual data comprises an image or a video;
extracting, by using a first processing block in a trained visual encoder, first feature information from the plurality of embedding representations according to a first attention mechanism;
extracting, by using a second processing block in the visual encoder, second feature information from the first feature information according to a second attention mechanism, wherein the first attention mechanism comprises one of the following, and the second attention mechanism comprises the other of the following:
a window attention mechanism in a spatial dimension, wherein the window attention mechanism is applied to respective video frames in the image or the video, or
a causal attention mechanism in a temporal dimension, wherein the causal attention mechanism is applied between consecutive video frames in the video; and
generating, by using a tokenizer in the visual encoder, an encoding representation corresponding to the visual data based on the second feature information.

2. The method according to claim 1, wherein the visual encoder comprises a first tokenizer and a second tokenizer, and wherein generating the encoding representation corresponding to the visual data comprises:
determining, by using the first tokenizer, a plurality of visual encoding codewords that match the second feature information from a codebook comprising visual encoding codewords; and/or
determining, by using the second tokenizer, the encoding representation corresponding to the visual data based on the second feature information and a predetermined distribution.

3. The method according to claim 1, wherein the first processing block and the second processing block are based on a Transformer model structure.

4. The method according to claim 1, further comprising:
decoding, by using a trained visual decoder, the visual data from the encoding representation; or
generating, by using the visual decoder, additional visual data based on the encoding representation and conditional information.

5. The method according to claim 4, wherein the visual decoder comprises at least a third processing block and a fourth processing block that are connected, wherein an input to the third processing block is processed in the third processing block according to the second attention mechanism, and an input to the fourth processing block is processed in the fourth processing block according to the first attention mechanism.

6. The method according to claim 1, wherein a training process of the visual encoder comprises at least:
training the visual encoder by using a sample image set with a fixed resolution in a first training stage; and
training the visual encoder by using a sample image set with different resolutions and a sample video set with different resolutions in a second training stage.

7. The method according to claim 6, wherein the visual encoder comprises a first tokenizer and a second tokenizer, and in the first training stage and the second training stage, a parameter of the first processing block, a parameter of the second processing block, and a parameter of the first tokenizer in the visual encoder are updated, but a parameter of the second tokenizer remains unchanged.

8. The method according to claim 7, wherein the training process of the visual encoder further comprises:
in a fine-tuning stage after the second training stage, updating a parameter of the first processing block, a parameter of the second processing block, and a parameter of the second tokenizer in the visual encoder by using a further sample image set with different resolutions and a further sample video set with different resolutions, but keeping a parameter of the first tokenizer unchanged.

9. An electronic device, comprising:
at least one processor; and
at least one memory, wherein the at least one memory is coupled to the at least one processor and stores instructions for execution by the at least one processor, wherein the instructions, when executed by the at least one processor, cause the device to perform acts comprising:
converting a plurality of image blocks divided from visual data into a plurality of embedding representations respectively, wherein the visual data comprises an image or a video;
extracting, by using a first processing block in a trained visual encoder, first feature information from the plurality of embedding representations according to a first attention mechanism;
extracting, by using a second processing block in the visual encoder, second feature information from the first feature information according to a second attention mechanism, wherein the first attention mechanism comprises one of the following, and the second attention mechanism comprises the other of the following:
a window attention mechanism in a spatial dimension, wherein the window attention mechanism is applied to respective video frames in the image or the video, or
a causal attention mechanism in a temporal dimension, wherein the causal attention mechanism is applied between consecutive video frames in the video; and
generating, by using a tokenizer in the visual encoder, an encoding representation corresponding to the visual data based on the second feature information.

10. The electronic device according to claim 9, wherein the visual encoder comprises a first tokenizer and a second tokenizer, and wherein generating the encoding representation corresponding to the visual data comprises:
determining, by using the first tokenizer, a plurality of visual encoding codewords that match the second feature information from a codebook comprising visual encoding codewords; and/or
determining, by using the second tokenizer, the encoding representation corresponding to the visual data based on the second feature information and a predetermined distribution.

11. The electronic device according to claim 9, wherein the first processing block and the second processing block are based on a Transformer model structure.

12. The electronic device according to claim 9, the acts further comprising:
decoding, by using a trained visual decoder, the visual data from the encoding representation; or
generating, by using the visual decoder, additional visual data based on the encoding representation and conditional information.

13. The electronic device according to claim 12, wherein the visual decoder comprises at least a third processing block and a fourth processing block that are connected, wherein an input to the third processing block is processed in the third processing block according to the second attention mechanism, and an input to the fourth processing block is processed in the fourth processing block according to the first attention mechanism.

14. The electronic device according to claim 9, wherein a training process of the visual encoder comprises at least:
training the visual encoder by using a sample image set with a fixed resolution in a first training stage; and
training the visual encoder by using a sample image set with different resolutions and a sample video set with different resolutions in a second training stage.

15. The electronic device according to claim 14, wherein the visual encoder comprises a first tokenizer and a second tokenizer, and in the first training stage and the second training stage, a parameter of the first processing block, a parameter of the second processing block, and a parameter of the first tokenizer in the visual encoder are updated, but a parameter of the second tokenizer remains unchanged.

16. The electronic device according to claim 15, wherein the training process of the visual encoder further comprises:
in a fine-tuning stage after the second training stage, updating a parameter of the first processing block, a parameter of the second processing block, and a parameter of the second tokenizer in the visual encoder by using a further sample image set with different resolutions and a further sample video set with different resolutions, but keeping a parameter of the first tokenizer unchanged.

17. A non-transitory computer-readable storage medium, wherein the computer-readable storage medium stores a computer program, and the computer program, when executed by a processor, implements acts comprising:
converting a plurality of image blocks divided from visual data into a plurality of embedding representations respectively, wherein the visual data comprises an image or a video;
extracting, by using a first processing block in a trained visual encoder, first feature information from the plurality of embedding representations according to a first attention mechanism;
extracting, by using a second processing block in the visual encoder, second feature information from the first feature information according to a second attention mechanism, wherein the first attention mechanism comprises one of the following, and the second attention mechanism comprises the other of the following:
a window attention mechanism in a spatial dimension, wherein the window attention mechanism is applied to respective video frames in the image or the video, or
a causal attention mechanism in a temporal dimension, wherein the causal attention mechanism is applied between consecutive video frames in the video; and
generating, by using a tokenizer in the visual encoder, an encoding representation corresponding to the visual data based on the second feature information.

18. The medium according to claim 17, wherein the visual encoder comprises a first tokenizer and a second tokenizer, and wherein generating the encoding representation corresponding to the visual data comprises:
determining, by using the first tokenizer, a plurality of visual encoding codewords that match the second feature information from a codebook comprising visual encoding codewords; and/or
determining, by using the second tokenizer, the encoding representation corresponding to the visual data based on the second feature information and a predetermined distribution.

19. The medium according to claim 17, wherein the first processing block and the second processing block are based on a Transformer model structure.

20. The medium according to claim 17, the acts further comprising:
decoding, by using a trained visual decoder, the visual data from the encoding representation; or
generating, by using the visual decoder, additional visual data based on the encoding representation and conditional information.
